(19) United States
(12) Patent Application Publication
(10) Pub. No.: US 2023/0043339 A1
(43) Pub. Date: Feb. 9, 2023

(54) Smart Argentinean Grill

(71) Applicant: Benjamin Cote, Los Angeles, CA (US)

(72) Inventor: Benjamin Cote, Los Angeles, CA (US)

(21) Appl. No.: 17/077,255

(22) Filed: Oct. 22, 2020

(51) Int. Cl. A47J 37/07; A47J 36/32

(52) U.S. Cl. CPC A47J 37/0786; A47J 36/321; A47J 37/0704; A47J 2037/0795; A47J 2202/00

(57) ABSTRACT

The present invention provides a cooking embodiment and method for cooking food through the manipulation of the distance between a food product and a heat source. Also, food temperature auxiliary systems used in conjunction with the aforementioned embodiment and method. The embodiment and method involve continuously measurement of cooking surface's temperature and system's humidity. The embodiment and methods also include optionally using multiple of the same embodiment if cooking more than one type of food is required at the same time. The auxiliary systems relate to build material supply hating and cleaning diagnostics, and monitoring operation of the embodiment.

### BACKGROUND

A type of cooking utilizing a container with charcoal positioned beneath a food supporting grid has become extremely popular in the last years. Modifications of the aforementioned containers commonly utilize a non-combustible heat absorbing and radiating material supported beneath the food grid and heated by a gas flame or electric resistance coils contained within the device, so as to simulate glowing charcoal. Other methods less common but also used are solar or even microwaves. Normally, such devices only use one type of fuel for operation, and their temperature control methods are normally adjusted by controlling the intensity of the heat emanated by the heat source. Making it difficult and unprecise to control the temperature around and in the food, and therefore, making it difficult to control the quality of the final product.

### SUMMARY

The invention relates to embodiments of cooking devices and, more particularly to grills adapted to control the cooking process by manipulating the temperature of the cooked object, for use in kitchens, restaurants, factories, or laboratories.

This embodiment contemplates an apparatus suitable for selective use as a conventional charcoal grill utilizing a gas-stove, electric resistance, solar, or other source of heat. The main purpose of the embodiment is to manipulate the temperature of food by moving the cooking surface being exposed to a heat source according to the measures provided by different probes.

The principle objects of the present invention are: to provide a suitable embodiment for cooking different types of food in a specific way for each type; to provide such a cooking device which may alternately be used with conventional charcoal, open flame cooking device, conventional range, electric resistance, other fuels or combinations of one or more of them; to provide such a cooking device which may take the form of a cast, relatively thick-walled structure or a relatively lightweight, sheet metal structure; to provide such a device suitable for cooking different types of food by adjusting the distance between the food and the heat source and the humidity around the food cooked; and to provide such a device which is relatively simple and inexpensive in construction and yet highly effective and long-lasting in the U.S.

Other objects and advantages of this invention will become apparent from the following description taken in connection with the accompanying drawings wherein are set forth by way of illustration and examples of certain embodiments of this invention.

In one aspect, the invention relates to an embodiment for controlling the cooking process of food by automatically changing the distance between the heat source and the cooking surface according to the heat and humidity measurements collected by the sensors.

In another aspect, the invention relates to an embodiment with a heat source which could be a combination of burning combustible organic material and/or system-generated heat (gas or electric) and an electronic circuit board that receives real-time feedback from the temperature probes. The control system comprises the software developed to control the cooking process by adjusting the distance between the cooking surface and the heat source in order to maintain the desired cooking temperatures and times selected through either manual settings, cloud-based settings, or pre-programmed recipe time and temperature.

In yet another aspect, the invention relates to an embodiment with specialized software that calculates the heat ratio emanated from the heat source, and according to that ratio, the software gives the hardware the order to move the cooking surface to a distance where the heat received by the food is optimal according to the cooking parameters set in prior.

### BRIEF DESCRIPTION OF THE DRAWINGS

In the drawings, like reference characters generally refer to the same parts throughout the different views.

FIG. 1 is a profile image of the embodiment where you can appreciate the display, the control knobs, the front, and side which are made of the same metallic material and the cooking surface. General view of the device.

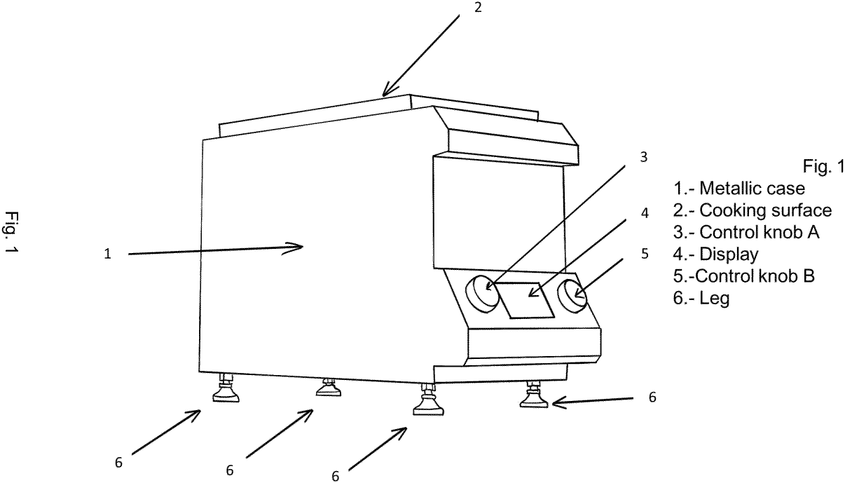

FIG. 2 is an image of the embodiment slightly seen from the side and from above where the cooking surface and its sensor can be observed. It shows the general shape of the appliance with its cooking surface.

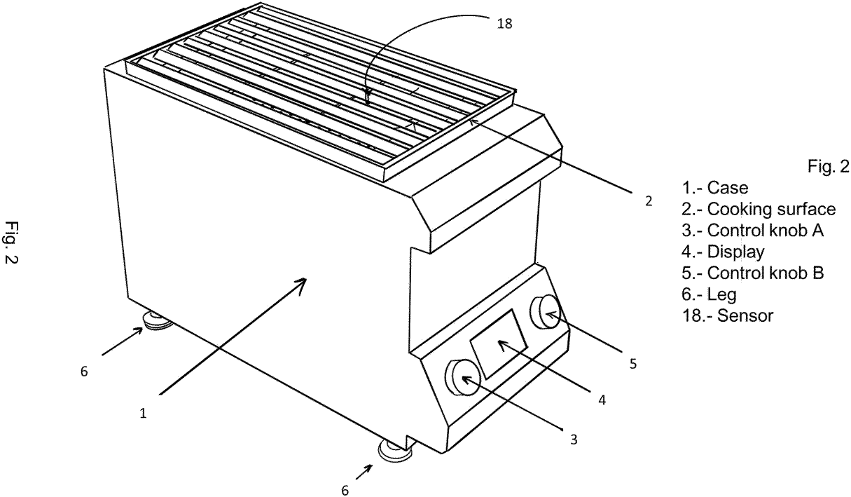

FIG. 3 is an image of the embodiment slightly to the side when viewed from the front showing the raised cooking surface with its supports. Its purpose is to show the elevation of the cooking surface.

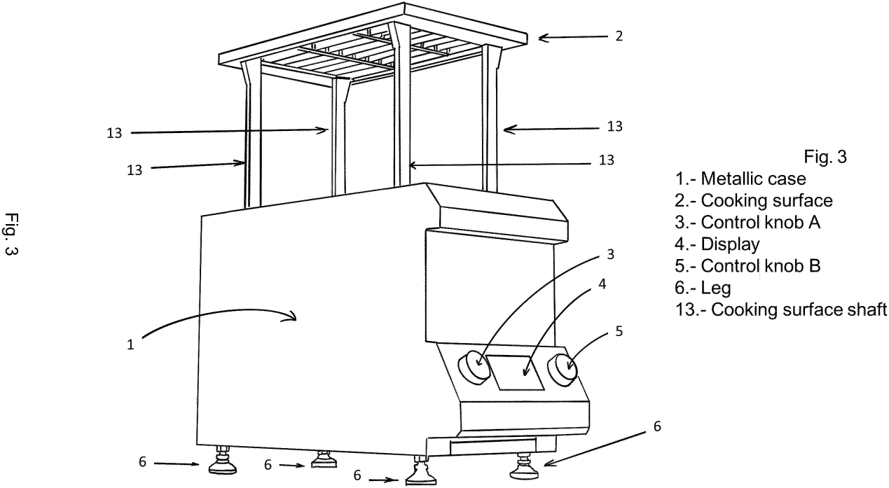

FIG. 4 is an image of the embodiment viewed from above and slightly to the side where the raised heating surface can be seen on its four supports. Its purpose is to show the charcoal holding grid which can be replaced by a different energy source.

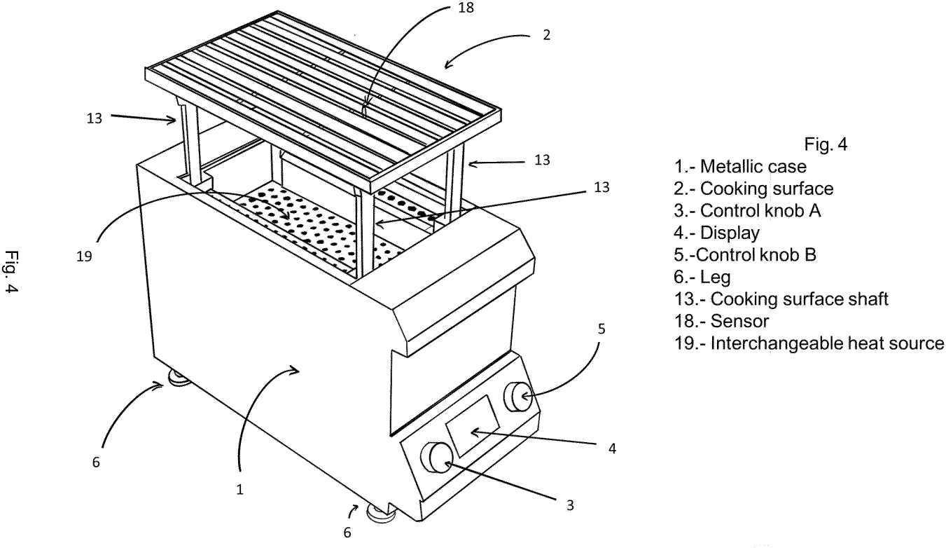

FIG. 5 is an image of the top view of the embodiment where the cooking surface has been removed Its purpose is to show the charcoal holding grid which can be replaced by a different energy source.

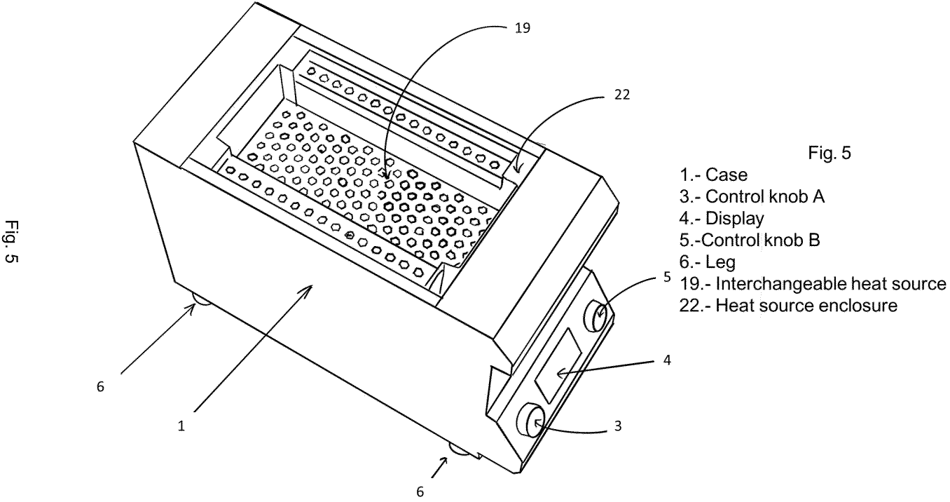

FIG. 6 is a top view of the embodiment where the cooking surface and heat source has been removed, here the heat diffuser can be seen.

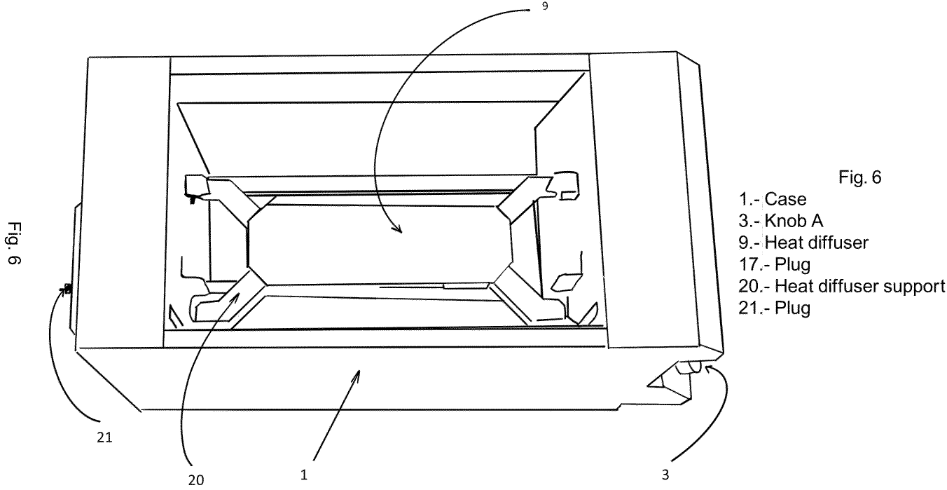

FIG. 7 is a cutaway view of the embodiment without the outer metal covers, this image is used to identify the thermal material plates and the appliance controls.

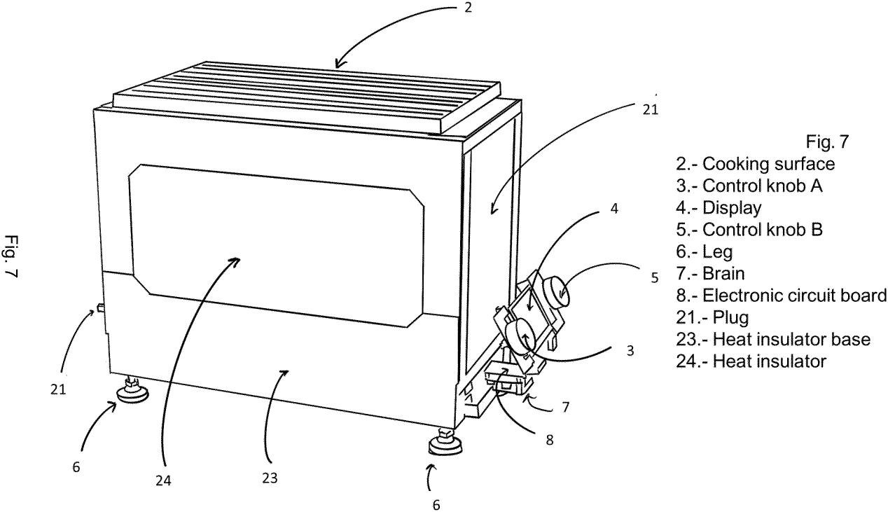

FIG. 8 is a side view of the inside of the embodiment where you can see mainly the internal parts of the appliance, those that are necessary for its operation.

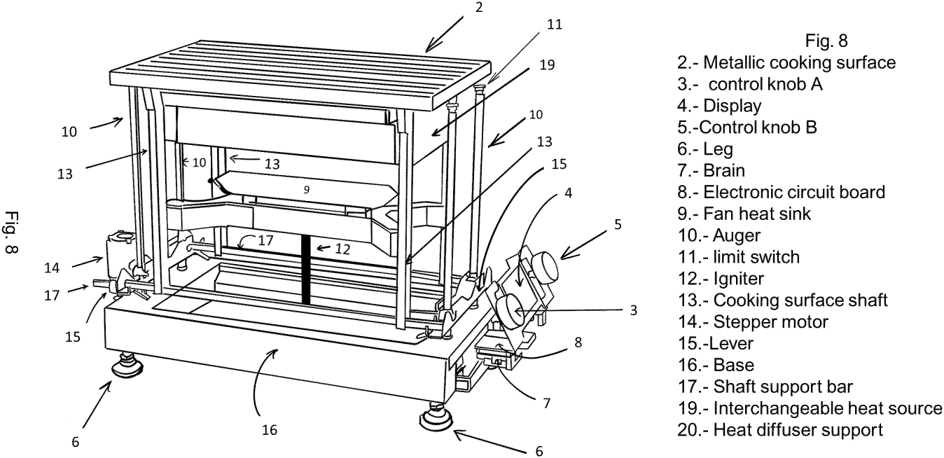

FIG. 9 is the inner structure of the embodiment without anything else than the shafts, risers, and supports that allow the system to move the cooking surface in order to reach the conditions set for the cooking process.

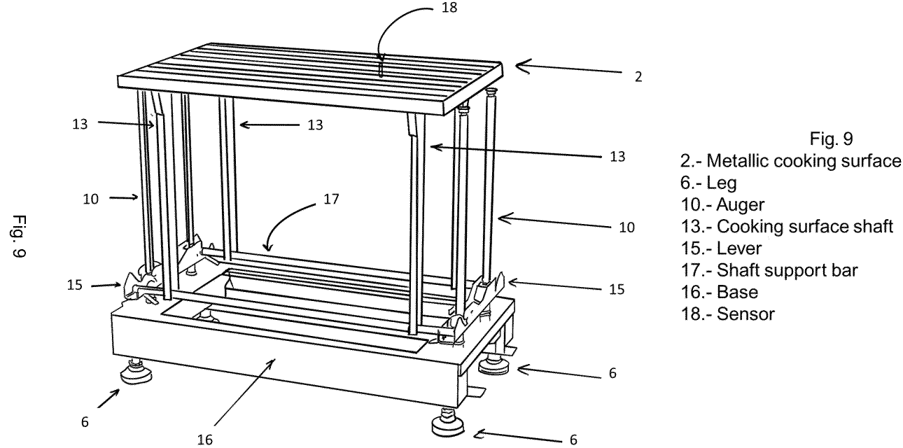

### DETAILED DESCRIPTION

The embodiment of the present invention is described below. It is, however, expressly noted that the present invention is not limited to this embodiment, but rather the intention is that variations, modifications, and equivalents that are apparent to the person skilled in the art are also included.

The System consists of temperature sensors [18] located in and around the cooking surface [2] and inside the food to be heated and around the heat source [19]; stepper motor [14], supports [20], shafts [13], heating surface [2] (grill, plate, dish, etc. ) large and resistant enough to hold the food to be heated; legs or apparatus support [6], Knobs [3] [5], screen LCD TFT [4], it also contemplates a brain [7] that receives the information and transforms it into data interpretable by a computer or a cell phone through an application; it has a WIFI connection system, it also includes an interchangeable heat source energy source [19], which can be gas, electric, coal, pellets or other combustible materials; An stepper motor controllers [8] to guarantee the movement of the object; limit switch [11] to avoid the failure of the motors due to the lack of an endpoint to the movement; it has automatic control of the gas valve [12].

The system allows controlling the ignition of the heat source [12] and the control of this, in case of choosing to use gas as fuel the system has a valve that regulates the output of the gas [12] in question, as well as a retrying sequence to avoid gas leakage. In addition, to maintain temperature control the system has a fan heat sink [9]. The information collected by the temperature sensors is revived by temperature controller chips locate on an electronic circuit board [8] with I2C, it has fault detection (open temperature inputs, shorted. Stepper motor faults), as well as a rotary encoder controller. The rotary encoder is hooked to the operating system navigation. It has a display driver for the TFT LCD display [4]. A brain [8]. A firing rate control algorithm for the igniter and a cooking surface position control algorithm where the object to be heated is located. Coordination of burner on/off states, controller service, fault detection service, operational interface service.

As for the user interface, the system can be controlled through menu navigation with encoders. It has a different menu and screen design to control temperatures, position, heating stage, heating time, setpoints, current mode; Handling, and notification of fault detection, such as jamming of a stepper motor or disconnection of a thermocouple input. It has storage of settings and configuration information. The system allows the user to choose between automatic or manual mode, starting and stopping the equipment, setting the cooking speed in manual mode; the setting of the different recipes and heating stages; storing and loading them; Managing the conditions of the heating stages, such as the temperature reached or managing the time between stages.

To use the system, the fuel to be burned must be prepared, this can be placed in the Interchangeable heat source [19] or it can be installed instead of the charcoal container grid this could be a resistance, a burner, or any other heat source. The food to be heated is placed on the cooking surface [2], then the system must be connected to the electric current and the power knob [3] or [5] must be pressed to turn on the system. On the display [4], a menu specially designed for the system will appear, in the menu, it can be selected the manual or automatic mode, if the automatic mode is chosen, the menu will change and will offer a box of options to choose heating conditions from the menu of preset and preloaded parameters in the system memory located at the electronic circuit board [8]. If on the other hand the Manual mode is chosen, the menu changes to a screen where the desired temperature, time, position, heating time, setpoints, current mode, and food material to be heated can be manually selected through the knobs [3][5].

Once all the factors for cooking the food have been selected, the knob [3] or [5] is pressed to accept the cooking conditions. When the process starts, the appliance sends a signal to the initiator [12] which turns on the heat source [19] and at the same time starts receiving the temperatures registered by the sensors [18]. These sensors send the information to the brain [7], the brain receives and analyzes the data and by calculating the heat received, the direction from which the heat is received; the humidity, the temperature of the cooking surface; the distance between the food and the energy source, defines the distance at which the stepper motor [14] must move the shafts [13] through the augers [10] in order to place the food in the ideal zone to receive the heat necessary to reach the desired temperature. This process occurs constantly and automatically throughout the cooking period, allowing the system to maintain the ideal cooking conditions for the food in a highly accurate manner. Finally, once the programmed heating time has elapsed, the system turns off the heating source and returns the cooking surface to the starting location.

What is claimed and desired to secure by letters patent is:

1. A cooking apparatus, comprising:
a. a cooking surface large enough to hold a food product
b. means for providing heat to said cooking surface
c. means for controlling the ignition of said heat source
d. means for automatically moving said cooking surface from said heat source
e. means for dissipating heat from said cooking source.
f. means for measuring:
1. temperature of said cooking surface
2. humidity of said cooking surface
3. rate of heat emanating from said heat source
4. distance between said heat source and said cooking surface
g. a memory that stores recipes and cooking instructions for cooking food products. h. a display which:
1. is connected to said memory for displaying the options registered in said memory
2. displays the current status and conditions of the food to be cooked.
i. means for manipulating the options shown on said display previously stored in said memory or that were manually entered by the operator and saving them in the memory
j. means for a human operator to enter instructions and store them in said memory
k. means for measuring the cooking conditions of said food product automatically and in real time
l. means for connecting said apparatus to other apparatus through wireless connections
m. means for interpreting the information obtained by said means for measuring food cooking conditions.
